(19) United States
(12) Patent Application Publication
(10) Pub. No.: US 2010/0083339 A1
(43) Pub. Date: Apr. 1, 2010

(54) DIGITAL BROADCASTING SYSTEM AND APPARATUS

(75) Inventor: Kazuhiko YOSHII, Kawasaki (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/488,717

(22) Filed: Jun. 22, 2009

(30) Foreign Application Priority Data
Aug. 29, 2008 (JP) 2008-220786

(51) Int. Cl. H04N 7/00; H04B 1/66

(52) U.S. Cl. 725/146; 375/240.25; 725/148; 375/E07.027

(57) ABSTRACT

A “program information constituent element table” is in common use at data transmitting locations, data relaying locations and data converting locations and plural programs are combined through high multiplexing to one MPEG-2 transport stream, thereby suppressing use of resources for network transmission among broadcasting bases.

### INCORPORATION BY REFERENCE

The present application claims priority from Japanese application JP2008-220786 filed on Aug. 29, 2008, the content of which is hereby incorporated by reference into this application.

### BACKGROUND OF THE INVENTION

The present invention relates to transmission of the MPEG-2 TS formed through multiplexing for the digital broadcasting and to transmission techniques employed in the field of local area broadcasting.

In the digital broad casting, the contents transmission between existing stations such as the nationwide broadcasting, when the contents to be broadcast are local programs, is subjected to substitution of program information and/or commercials images in local broadcasting stations through transmission of contents materials over leased or private lines established in advance between the existing stations or through real-time transmission by making use of satellite channels.

Multiplexed data to be transmitted is broadcast from one broadcasting station in which one program (containing digital image, digital audio, data) constitutes a unit group. Therefore, the broadcasting station is required to complete edition of all programs and multiplexing of all programs.

At present, between a key station and local stations, contents are received in the form of a video and audio information source in a complete package containing all information necessary for broadcasting, and multiplexing is performed for one local station on the local station side for broadcasting.

As described in Ref. 1, Japanese literature “Relaying World Track and Field 2007 in Osaka”, HOSO GIJUTSU (or BROADCASTING TECHNOLOGY) 2007, VOL. 60, NO. 12, pp. 59-85, Kenrokukan Publishing Co., in the present circumstances, the broadcasting is such that a series of processes from creation of contents materials to edition of programs for broadcasting are accomplished on the assumption that one program is distributed over one channel. In the digital terrestrial broadcasting, a broadcasting station prepares their program editions by making use of a frequency band of 6 MHz at a frequency assigned thereto. The digital terrestrial broadcasting may be in the form of a one-segment broadcasting, an SDTV (Standard Definition Television) broadcasting which delivers three programs of SDTV quality at most or an HDTV (High Definition Television) broadcasting which delivers one program of HDTV quality. The one-segment broadcasting is intended to offer contents delivery services to cellular phones and mobile terminals by making use of one particular segment among plural segments into which one frequency band channel is divided.

There have already been popularly used 20,000,000 one-segment digital terrestrial broadcast receivers (hereafter, referred to as “one-segment receivers” for convenience sake) or so. The one-segment broadcasting is a broadcast service in which only one segment (i.e., 0-th segment situated at a center among 13 segments into which one channel assigned to a broadcasting is divided) is used to offer various services. As shown in FIG. 1, the one-segment broadcasting makes use of only one segment for broadcasting one program over one channel, irrespective of whether a simulcast is performed or not. The simulcast means that one and the same station broadcasts an identical program at the same time period both by means of the full segment broadcasting and by means of the one-segment broadcasting.

At present, the one-segment broadcasting is subjected to the simulcast so that multiplexed broadcast data are produced by re-encoding SD or HD quality contents or by encoding contents from a video source and are broadcast.

The contents under broadcasting include programs such as contents recorded in HDDs and video sources provided by the real-time encoder and include real-time programs such as relay broadcast contents and live broadcast contents. These broadcast contents sources are once gathered into a broadcast station and are subjected to multiplexing for broadcasting.

### SUMMARY OF THE INVENTION

Since the amendments of the Broadcast Act, it has now been easier to obtain a license for the low power broadcasting, and it is expected that there will be many broadcasters who aim at broadcasting to particular areas or to limited viewers. At present, channels 13 to 62 in the UHF (Ultra High Frequency) band are assigned to the digital broadcasting, and there is a trend towards the one-segment broadcasting using 13 segments to the maximum per one channel by applying thereto the one-segment broadcasting techniques, which is now under discussion to establish the ISDB-Tmm (Integrated Service Digital Broadcasting-Terrestrial for Mobile Multimedia) service specifications and others.

In the broadcasting system illustrated in FIG. 2, plural segments of one frequency band of one channel are independently utilized each for effecting broadcasting. When there exist plural local broadcasts in an area by making use of the same segment in the same channel with no interference therebetween, it will be necessary to provide the broadcasting bases with multiplexed broadcast data necessary for the broadcasting.

It is conjectured that the transmission system using the IP (Internet Protocol) will be useful for transmitting an MPEG-2 TS (Transport Stream) to a large number of such broadcasting stations. However, in order to accomplish the data-guaranteed IP transmission to each broadcasting station from a remote place, it will be required that both the sender and the receiver be provided with a broadcasting equipment interface including a DVB-ASI (Digital Video Broadcasting-Asynchronous Serial Interface) and an IP converter. Consequently, each time the number of the broadcasting bases is incremented, one IP converter must be additionally provided in the contents distributing sender.

Since the broadcasting is, by its nature, such that some transmission data should be sent continuously, which entails an increase of the equipment cost and an increase of the number of IP connections. Further, the broadcasting performs services with IP network resources kept in use, which will lead to a lack of network equipment resources for the transmission channels.

According to the MPEG-2 TS standards, an ID called a PID (Packet Identification) is independently assigned to each of digital video, digital audio, data, PSI/SI (Program Specific Information/Service Information) within a MPEG-2 TS. The PID is a 13-bit data which covers 8,191 available numbers. At least 10 IDs or so are used for each MPEG-2 TS. Therefore, roughly speaking, one contents distributing sender is allowed to send 800 different programs.

With the local area-specific broadcasting, since a large number of broadcasting equipments are provided, and since to establish long time IP connections in the peer-to-peer fashion for all places including physical locations (specific local areas) and logical locations (tenants-rented composite buildings, nationwide chain stores, etc) is considered as provision of leased or private lines in the respective places, it is difficult to secure plural long time-connection network resources with low-cost lines.

Further, with the conventional broadcasting equipments, it is necessary to once subject to-be-broadcast contents to the authoring process on the broadcasting station side. For example, when live video contents at a broadcast location are delivered to a corresponding local area, it is necessary that the video contents once have be passed to a broadcasting equipment for the their delivery or distribution, which necessitates establishment of bidirectional communication connection between the local area and the broadcasting station for a long time with a sufficient bandwidth secured. This will result in a substantial cost increase.

According to one aspect of the present invention, an MPEG-2 TS transmitted over an IP network are subjected to demultiplexing/multiplexing in real time and network resources for transmission are concentrated, whereby contents creators or owners are allowed to distribute their live videos to specific areas, without resort to equipments in the broadcasting stations.

According to another aspect of the present invention, broadcast contents are categorized in physical and logical locations and plural streams of the contents are subjected to re-multiplexing to provide a single stream.

In accordance to the teaching of the above-described or other aspects of the present invention, a local area-specific broadcasting system and apparatus enjoy insurance of the network resources, alleviation of the bandwidth control overhead, optimization of the traffic on transmission lines by the re-multiplexing, and/or reduction of concentration of supervising equipments and risk dispersion by the service decentralization.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the conventional one-segment broadcasting system.

FIG. 2 is a diagram showing an example of a one-segment broadcasting system in which plural one-segment broadcast contents are multiplexed on one channel having a band width of 6 MHz.

FIG. 3 is a diagram showing an example of a digital broadcasting system according to one embodiment of the present invention.

FIG. 4 is a diagram showing an example of a functional structure of a program center server 301 which may be used in a digital broadcasting system according to one embodiment of the present invention.

FIG. 5 is a diagram showing an example of a re-multiplexing unit for transference 304 which may be used in a digital broadcasting system according to one embodiment of the present invention.

FIG. 6 is a diagram showing an example of connection between the program center server 301 and the re-multiplexing unit for transference 304 in one embodiment of the present invention.

FIG. 7 is a diagram showing an example of contents distribution in one embodiment of the present invention.

FIG. 8 is a diagram showing an example of a program table 402 in a program center server 301 in one embodiment of the present invention.

FIG. 9 is a diagram showing an example of a TS router control profile 408 in program center server 301 in one embodiment of the present invention.

FIG. 10 is a diagram showing an example of a program table 502 in a re-multiplexing unit for transference 304 in one embodiment of the present invention.

FIGS. 11A to 11C are diagrams showing examples of TS router control profiles 508a, 508b and 508c in respective re-multiplexing unit for transference (TS routers) 304 in one embodiment of the present invention.

FIG. 12 is a diagram showing an example of a structure of, a manner of insertion into and a manner of demultiplexing from a data stream 1200 in one embodiment of the present invention.

### DESCRIPTION OF THE EMBODIMENTS

Some embodiments of the present invention will now be described with reference to the accompanying drawings.

### Embodiment 1

First, an example of broadcasting environments in which this embodiment is intended will be described. This embodiment is intended for a local area broadcasting of a relatively small scale, in which many local area-specific broadcasting transmitters are provided for broadcasting bases such as local areas, floors of buildings, etc. so that they transmit and receive broadcasts to/from each other.

Installation of a broadcasting system in a certain local area enables a user to broadcast recorded/edited “programs” to an intended “place” such as a shopping mall, an office building or a park, by the use of radio broadcasting equipments or the like. For this purpose, the one-segment broadcasting technology may be utilized. For viewing the “programs”, use is made of fixed or stationary terminals such as PCs and TVs or portable terminals such as cellular phones and PDAs (Personal Digital Assistants), which have a function of receiving one-segment broadcasts.

The existing one-segment broadcasting normally offers services, using only one segment within the 6 MHz bandwidth. This embodiment, however, is intended for an environment in which other segments may be used for broadcasting by a system identical with the one-segment broadcasting system.

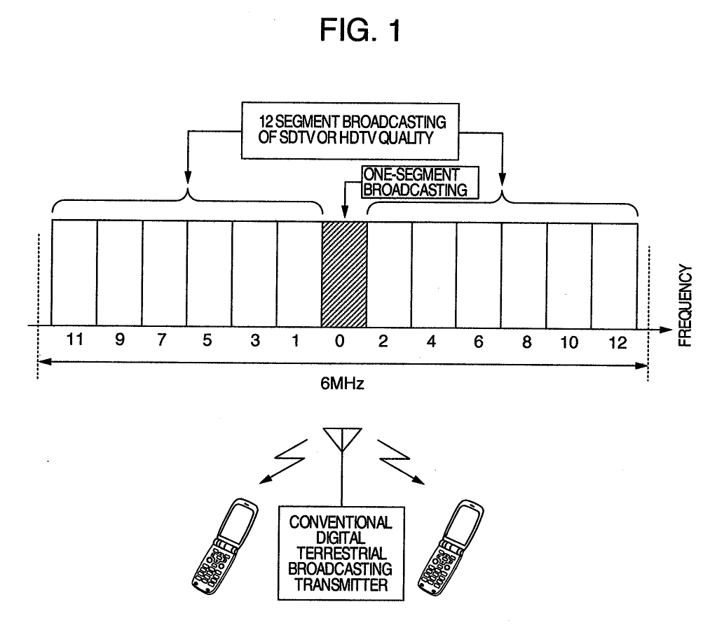

As is shown in FIG. 1, for the conventional one-segment broadcasting, only one segment in the 6 MHz bandwidth of one channel is assigned thereto. In the drawing, only Segment 0 is prepared for the one-segment broadcasting with the other segments being used for a 12-segment broadcasting of SDTV or HDTV quality.

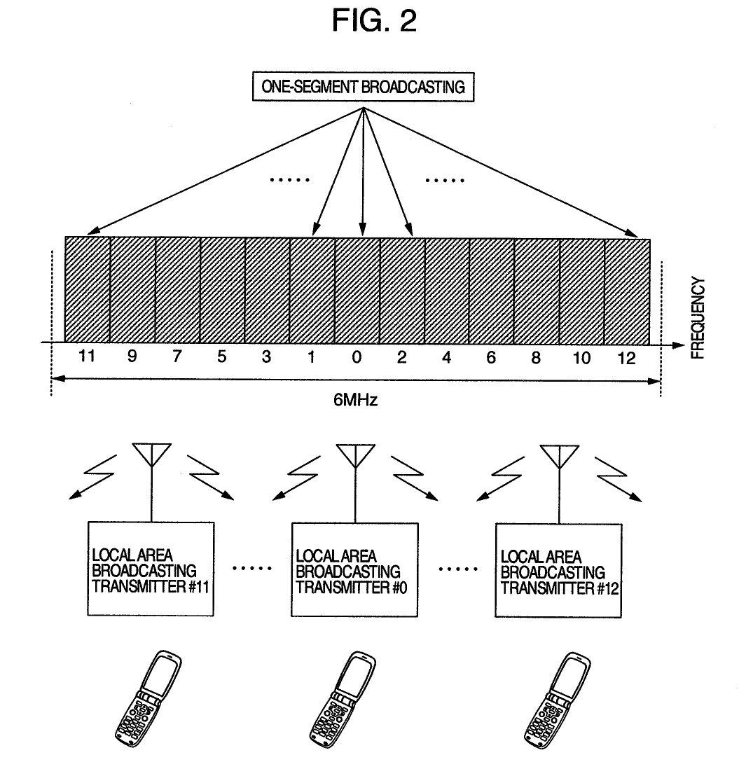

Referring to FIG. 2, in the environment intended for by this embodiment, on the other hand, the whole of the 6 MHz bandwidth of one channel is sued for the one-segment broadcasting. In this embodiment, the one-segment broadcasting uses the whole of the one channel bandwidth, but a part of the one channel bandwidth may be used therefor.

As an example, it is assumed that a system of this embodiment is installed in a local area where there exist a “shopping mall”, an “office building” and a “park”.

It is further assumed that three servicing users (individuals, groups, companies, etc), “user 0”, “user 1” and “user 2” take part in the services to be offered by using the present system, and that the “user 0” uses Segment 0 to broadcast “program 0” to the shopping mall and the office building, the “user 1” uses Segment 1 to broadcast “program 1” to the shopping mall and the park, and “user 2” uses Segment 2 to broadcast “program 2” to the shopping mall and the park, respectively.

Under these circumstances, the shopping mall receives broadcasting services of “program 0”, “program 1” and “program 2” from the three servicing users, so that client users in the shopping mall, using their one-segment receivers such as cellular phones, choose one among the three programs, “program 0”, “program 1” and “program 2” which is the most interesting to them.

As described above, with all of the 13 segments in one channel used for the local one-segment broadcasting, it is possible to broadcast many programs to one local area. As for the wide area one-segment broadcasting, by avoiding use of those segments which correspond thereto, there will be no fear of channel confusions.

Description will now be made of a stream in the digital broadcasting. Digital video, digital audio and/or data are combined into one stream in the form of an MPEG-2 TS so that it is modulated and emitted as radio waves (including those in the case of CATV) in a base station.

At present, a broadcasting station transfers contents items (programs) to broadcasting centers in such a manner that each broadcasting center as one broadcasting base receives one contents item (program). Normally, a “program” in the digital broadcasting includes a plurality of constituent elements such as “digital video” constituted by images to be broadcast, “digital audio” used for the BGM for the program and others and “data” for providing information on prize competition entry, news, program table, etc. These constituent elements forming a program are combined into one for broadcasting.

In other words, to broadcast “program A”, its constituent elements, “digital video A”, “digital audio A” and “data A” are combined into one data stream, which is transmitted from a broadcasting center to a broadcasting equipment or unit.

In this embodiment, a digital data to be finally carried on a broadcasting wave is multiplexed with one-segment data from plural broadcasting bases to thereby send broadcasting digital data to other areas. From this, a “high multiplex” MPEG-2 TS is produced in which a plurality of programs are multiplexed. Namely, plural “programs” are broadcast in the form of a data stream.

In the conventional broadcasting system, when “program A”, “program B” and “program C” are to be broadcast, one data stream is produced for each of the programs and is sent from a broadcasting center to its associated broadcasting equipment, as described above. Thus, the “program A”, “program B” and “program C” are each individually transmitted in the form of a data stream including “digital video A”, “digital audio A” and “data A”, in the form of a data stream including “digital video B”, “digital audio B” and “data B” and in the form of a data stream including “digital video C”, “digital audio C” and “data C”, respectively.

On the other hand, in the broadcasting system according to this embodiment, “program A”, “program B” and “program C” are combined into a single data stream for broadcasting. Namely, the single data stream includes: “digital video A”, “digital audio A” and “data A”; “digital video B”, “digital audio B” and “data B”; and “digital video C”, “digital audio C” and “data C”.

In the conventional broadcasting system, the same number of connections have to be established between broadcasting centers and broadcasting equipments as the number of programs for forming of data streams. In the broadcasting system of this embodiment, plural programs are multiplexed to a single stream, which makes it possible to transmit all programs with one stream. By this, the number of connections between equipments can be reduced, and use of equipment resources can be suppressed.

This embodiment is intended to make use of the MPEG-2 TS standards for multiplexing digital information (digital video, digital audio, data, etc) for transmission. According to the MPEG-2 TS standards, data of plural programs included in the PSI/SI (Program Specific Information/Service Information) of the MPEG-2 TS are used for the respectively associated information (audio information multiplexing, program zapping, etc) or multi-channel broadcasting. In this embodiment, on the other hand, the MPEG-2 TS is used as a transporter format without correlation between programs. Although, usually, information called PMT (Program Map Table) containing PIDs of video, audio and data included in a program is used to describe therein information on associated plural programs, in this embodiment, a PID is uniquely determined for each elementary stream in accordance with the MPEG-2 TS standards (ISO/IEC 13818-1), and the correlation is under control of the broadcasting center. Thus, it is impossible to discover, only from data streams transmitted in the transmission channels or lines, any correlation between the data.

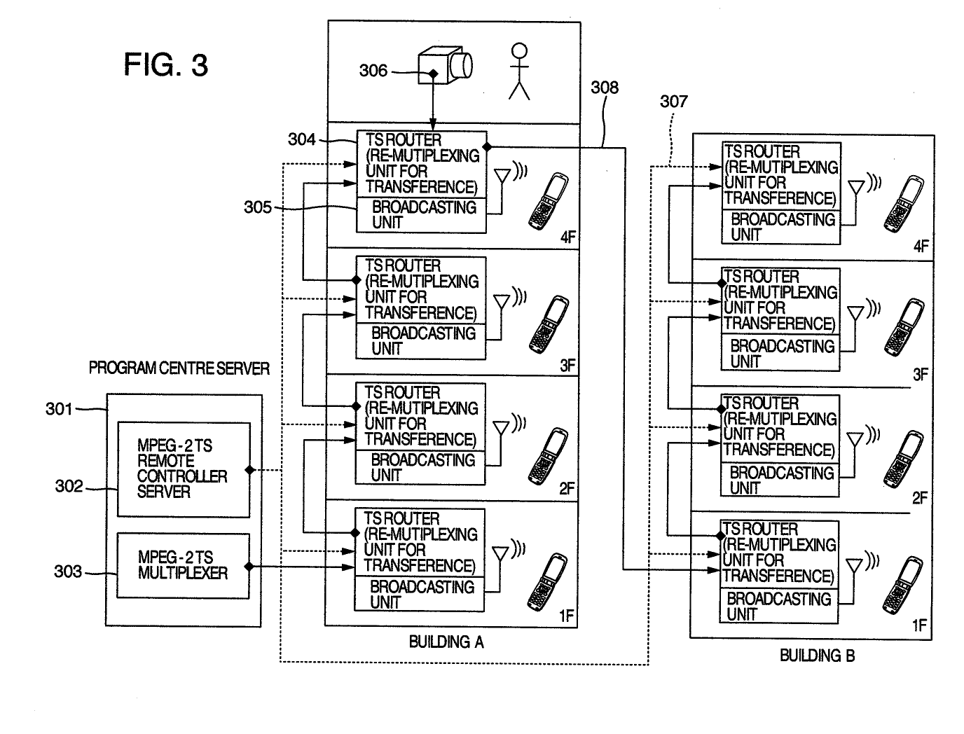

FIG. 3 shows an outline of an example of a contents distributing system in a local area broadcasting system according to one embodiment of the present invention. According to the contents distributing system, a broadcasting base is provided for each floor in a building so that contents are distributed to or received from each other. The system mainly includes a program center server 301, re-multiplexing units for transference (TS routers) 304, broadcasting units 305 and recording/editing units 306. As shown, the program center server 301 is connected with each of the re-multiplexing units for transference (TS routers) 304 through a control information communication line 307. Further, program center server 301 and the TS routers 304 are connected in tandem (in the “relay race” fashion) through data stream communication lines 308 for transmission and reception of a data stream. Clearly, each equipment or apparatus may be further connected with additional equipments or apparatus.

The program center server 301 controls the whole system and includes an MPEG-2 TS remote controller server 302 for supplying control information to the TS routers 304 and an MPEG-2 TS multiplexer 303 for supplying a data stream containing multiplexed contents (programs) to the TS routers 304.

The TS routers are provided one for each broadcasting base. When the TS routers 304 receives a data steam and the received data stream contains contents to be broadcast in the area for which the TS routers 304 is responsible, demultiplexes these contents so that they are broadcast by the broadcasting unit 305 associated therewith. If there are contents recorded/edited in that responsible area, the TS routers 304 will receive the recorded/edited contents from the recording/editing unit 306 associated therewith, will multiplex it with the data stream, and will transmit the resulting data stream to the next TS routers 304.

A flow of the program broadcasting may be as follows. The program center server 301 starts broadcasting. The data stream is relayed one to another between adjacent TS routers 304, so that the programs are successively transferred to the first through fourth floor in building A and then to first through fourth floor in building B. Each of the TS routers 304, if there is contained, in the received broadcast program data, a program to be broadcast in the floor (broadcasting base) for which the TS router is responsible, its associated broadcasting unit 305 broadcasts the program under consideration, while if not, the TS router transfers the received data stream to the next TS router as it is. Since the TS router 304 may be connected with a recording/editing unit 306 such as a camera having a function of encoding images, a “program” recorded/edited by the unit 306 at its responsible floor is taken in by the TS router for transference to other broadcasting bases. Thus, the TS router 304 itself serves as a broadcasting station.

The overall structure of the system in this embodiment is generally such that a broadcasting station (a re-multiplexing unit for transference or a TS router 304) capable of recording/editing and broadcasting is provided for each area (each floor) so that programs are transmitted to and received from each other between the broadcasting stations. The program center server 301 manages control information as to which program is to be broadcast and recorded/edited by which broadcasting station as well as other control information. The control information is distributed to the respective broadcasting stations (TS routers 304) so that they are operative to broadcast and transfer data streams in accordance with the distributed control information.

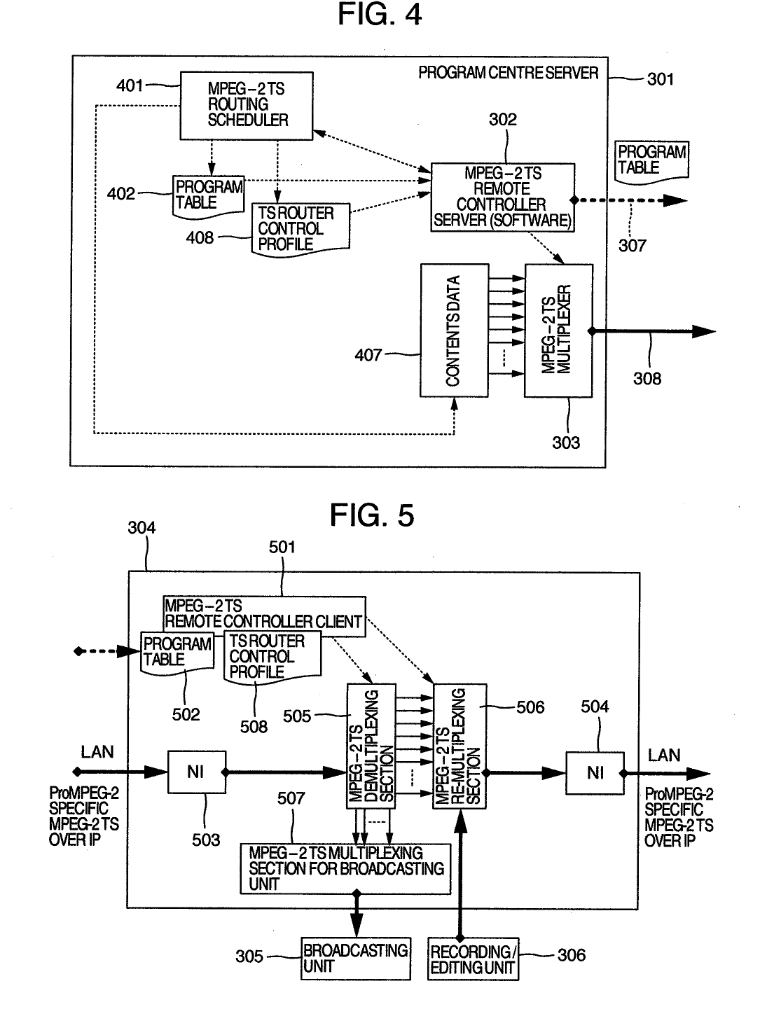

FIG. 4 shows details of an example of a program center server 301 which may be used in a digital broadcasting system according to one embodiment of the present invention. The program center server 301 includes an MPEG-2 TS remote controller server 302, an MPEG-2 TS multiplexer 303, an MPEG-2 TS routing scheduler 401, a program table 402, a TS router control profile 408 and contents data table 407.

The MPEG-2 TS remote controller server 302 serves to supply or transmit a program table 402 and a TS router control profile 408 to the TS routers 304. Use is made of the control information communication line 307 for the transmission of the program table 402 and the TS router control profile 408.

The program table 402 and the TS router control profile 408 are produced by the MPEG-2 TS routing scheduler 401.

The MPEG-2 TS multiplexer 303 serves to multiplex the contents data (programs) 407 to provide a data stream and transmit it to the TS routers 304. Use is made of the data stream communication line 308 for the transmission of the data stream.

The program table 402 carries information on programs which are to be broadcast to the whole area for which the present system is installed. In the example shown in FIG. 3, the program center server 301 distributes, to the TS routers 304, the program table 402 containing information on all of the programs to be broadcast in the buildings A and B.

The TS router control profile 408 defines functional operations to be performed by the TS routers 304 at the time when they receive a data stream. Unlike the program table 402, different data is distributed to each individual TS router 304.

FIG. 5 shows details of an example of a re-multiplexing unit for transference (TS router) 304 which may be used in a digital broadcasting system according to one embodiment of the present invention. The TS router 304 includes an MPEG-2 TS remote controller client 501, network interfaces (NI) 503 and 504 each having an FEC (Forward Error Correction) section, an MPEG-2 TS demultipexing section 505, an MPEG-2 TS re-multiplexing section 506 and an MPEG-2 TS multiplexing section 507 for broadcasting unit.

The MPEG-2 TS remote controller client 501 serves to control the operations of the MPEG-2 TS demultipexing section 505 and the MPEG-2 TS re-multiplexing section 506. The MPEG-2 TS remote controller client 501 receives through the control information communication line 307 the program table 502 and a TS router control profile 508 from the remote controller server 302.

The MPEG-2 TS remote controller client 501, based on the program table 502 and the TS router control profile 508 received, determines which of the programs contained in a received data stream should be separated or demultiplexed therefrom for broadcasting in the area for which the TS router is responsible and determines which of the programs should be re-multiplexed for transference to the next TS router 304. Details of the program table 502 and the TS router control profile 508 will be described later.

Assuming, for example, that a received data stream contains, “program A”, “program B” and “program C”, the MPEG-2 TS remote controller client 501 determines that “program A” and “program B” should be broadcast in the area for which the TS router is responsible, a new “program D” should be recorded/edited in that area and that “program B”, “program C” and “program D” should be re-multiplexed for transference to the next TS router 304.

The FEC section, being for correcting forward errors, serves to restore, in case some information is lost in the course of transference, the lost information by the means of a redundant code added on a sender side.

The MPEG-2 TS demultiplexing section 505 serves to split a received data stream for thereby demultipexing data. The received data steam is once split into individual data in the MPEG-2 TS demultiplexing section 505 so that those data which are to be broadcast in the area for which the TS router is responsible are transmitted via the MPEG-2 TS multiplexing section 507 for broadcasting unit to the broadcasting unit 305. The broadcasting unit 305 broadcasts the programs thus received.

The MPEG-2 TS re-multiplexing section 506 serves to again multiplex the demultiplexed programs to a data stream. When there is a program recorded/edited in the area for which the TS router is responsible, such program is transmitted through the recording/editing unit 306 to the MPEG-2 TS re-multiplexing section 506 and is combined thereat with programs which were demultiplexed at the MPEG-2 TS demultipexing section 505 in such a manner that only those programs which should be transferred to the next TS router 304 are re-multiplexed to form a data stream. The data stream formed through the re-multiplexing is transferred through the FEC processing section 504 to the next TS router 304.

The MPEG-2 TS multiplexing section 507 for broadcasting unit serves to multiplex data of those programs which are to be broadcast in the area for which the TS router is responsible, among the data demultiplexed at the MPEG-2 TS demultiplexing section 505, and serves to transmit the multiplexed data to the broadcasting unit 305.

The MPEG-2 TS demultipexing section 505 and the MPEG-2 TS re-multiplexing section 506 are under control by the MPEG-2 TS remote controller client 501 to determine which “programs” should be transmitted to the broadcasting unit 305 for the area for which the TS router is responsible, and to determine which “programs” should be re-multiplexed for transference to the next TS router 304, respectively.

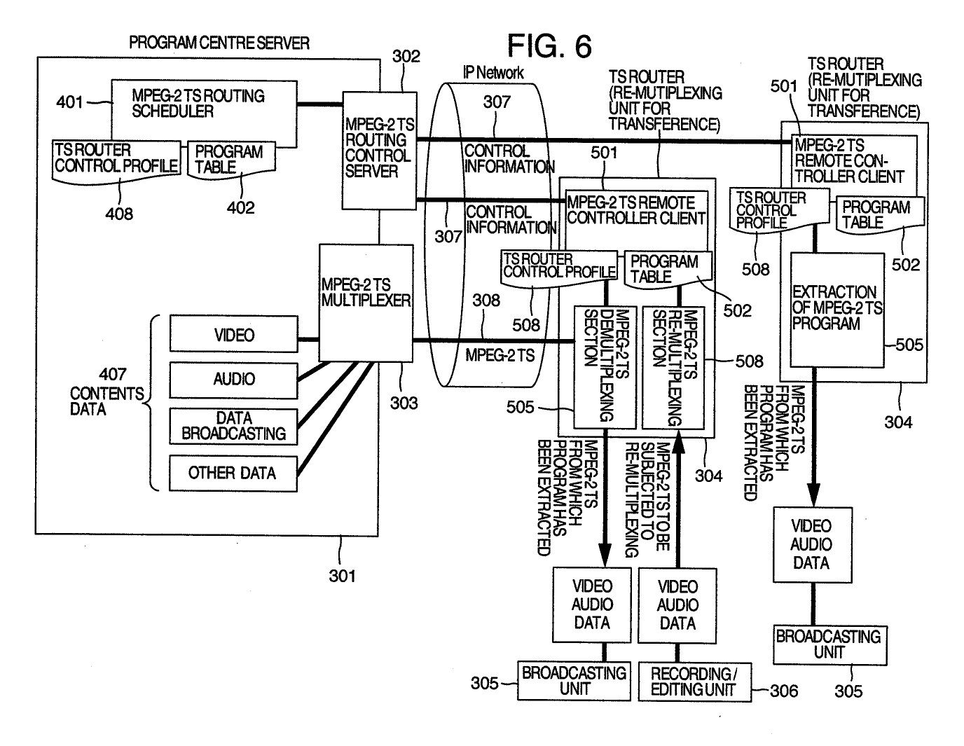

FIG. 6 shows an example of connection between the program center server 301 and the re-multiplexing unit for transference 304 in one embodiment of the present invention. The program center server 301 is connected with the re-multiplexing unit for transference 304 by the control information communication line 307 for supplying the TS router control profile 408 and by the data stream communication lines 308.

The control information communication line 307 connects the program center server 301 with each of the TS routers 304, while the data stream lines 308 connect the program center server 301 with a one of the TS routers 304, and connect the one TS router as well as the other routers 304 in tandem (in the “relay race” fashion).

First, the MPEG-2 TS routing control server 302 in the program center server 301 transmits the program table 402 and the TS router control profile 408 through the control information communication line 307 to the MPEG-2 TS controller client 501 in the TS router 304, thereby completing a preparation for transmission/reception of data streams.

Next, the MPEG-2 TS multiplexer 303 in the program center server 301 transmits programs through the data stream communication line 308 to the MPEG-2 TS demultipexing section 505 in the TS router 304.

The TS router 304 refers to the program table 502 and the TS router control profile 508 to process the data stream containing the programs.

In the conventional broadcasting system, it is necessary to establish a connection between a broadcasting station and a broadcasting base for each program, so that the number of connections increases by the number of the programs. If there are many local area-specific broadcasting bases, the number of connections will be increased by the number of the broadcasting bases, too. In the system according to this embodiment, however, plural programs are multiplexed so that transmission is possible with one connection.

In addition, the program center 301 need not transmit data to all of the TS routers 304, by virtue of a structure such that broadcast program data are transferred one to another to thereby suppress the load on the equipments and consumption of the network resources. Further, since each of the TS routers 304 is provided with the program table 502 and the TS router control profile 508, it is possible to dynamically determine which program should be broadcast in which broadcasting base.

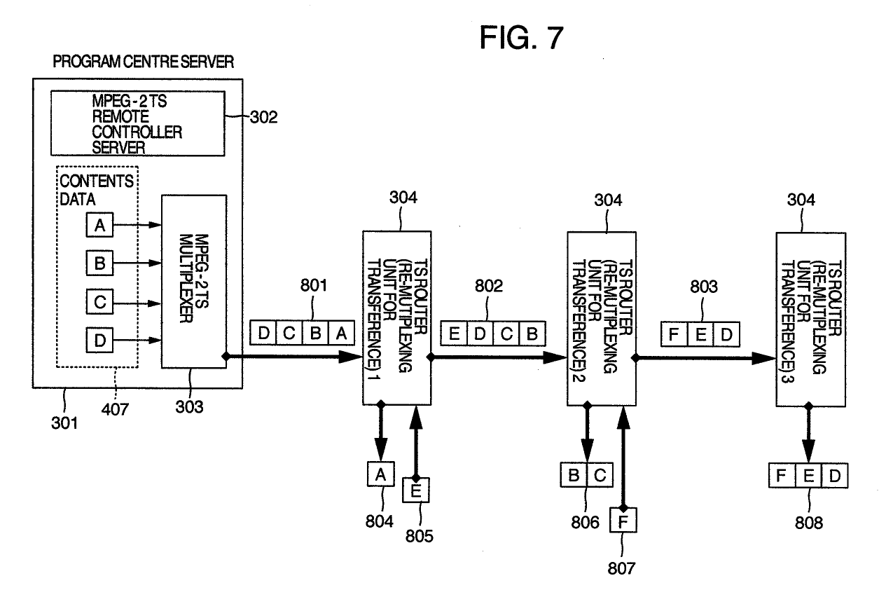

FIG. 7 showing an example of contents distribution in one embodiment of the present invention diagrammatically illustrates the manner in which the contents data in the whole system are multiplexed, demultiplexed and broadcast. It is assumed here that contents data A, B, C and D are transmitted. The program table 502 and the TS router control profile 508 will be described later.

It is further assumed that, in FIG. 7, each of the contents data A, B, C and D constitutes one program. Although each program is simply represented for convenience of explanation, it contains a plurality of constituent elements such as “digital video”, “digital audio”, “data”, etc, as described above.

First, the MPEG-2 TS multiplexer 303 in the program center server 301 multiplexes the contents data A, B, C and D to a data stream 801, which is then transmitted to a first TS router 304 (TS router 1). In the first TS router 304, program A 804 is demuliplexed for broadcasting in the area for which the first TS router is responsible, a program E 805 is recorded/edited, and the programs B, C, D and E are re-multiplexed to a data stream 802, which is transmitted to a second TS router 304 (TS router 2).

In the second TS router 304 (TS router 2), the programs B and C 806 are demultiplexed for broadcasting in the area for which the second TS router is responsible, a program F 807 is recorded/edited, and the programs F, E and D are re-multiplexed to a data stream 803, which is transmitted to a third TS router 304 (TS router 3).

In the third TS router 304 (TS router 3), programs F, E and D 808 are demultiplexed for broadcasting in the area for which the third TS router is responsible, and the whole contents are discarded because there is no subsequent TS router 304.

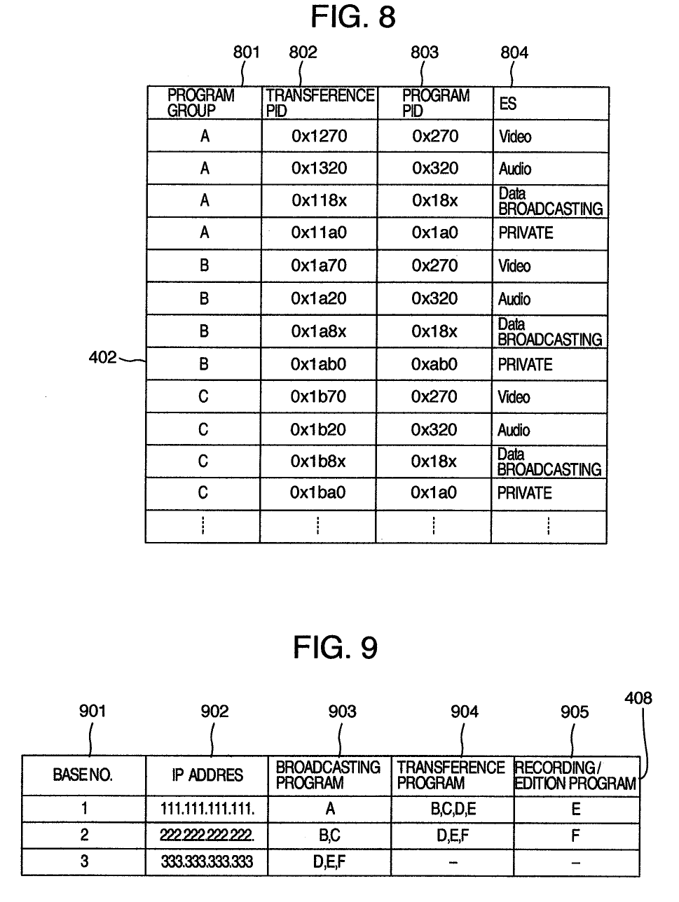

Reference will be made to the program table 402 and the TS router control profile 408 provided in the program center server 301 and to the program table 502 and TS router control profile 508 provided in the TS router 304. It should be noted that all of the illustrations in FIGS. 8 to 12 are consistent with the operation of the system shown in FIG. 7.

FIG. 8 shows an example of a program table 402 provided in a program center server 301 in one embodiment of the present invention. The program table 402 stores therein information for each constituent element of a “program”. For example, the information is prepared for each “digital video”, for each “digital audio”, etc.

The program table 402 may consist of a program group 801, a transference PID 802, a program PID 803 and an ES (Elementary Stream) 804. The group 801 indicates which program the ES constitutes. As an example, the group 801 may be an ID of a program or a title of a program representing the program. In the table shown in FIG. 8, first to fourth rows are constituent elements of program A. The transference PID 802 indicates a PID given when contents are transmitted/received through the transference data stream communication lines 308. The program PID 803 is a PID given when contents to be broadcast are transmitted from the TS routers 304 to the broadcasting unit 305 in the area for which the TS router is responsible. Details of the PID will be described later.

The ES 804 indicates an elementary stream such as coded video, coded audio, etc. For example, in the first row, the ES is “Video” representing “digital video”, while in the second row, the ES is “Audio” representing “digital audio”.

In this embodiment, two PIDs, the program PID and the transference PID are used. The PID means a packet identifier, and, by referring thereto, it can be determined what a packet contained in a data stream is the data of. The PID assumes a predetermined value for each ES, the PID being “0x270” for “Video” and “0x320” for “Audio”, and so forth.

Here, in the conventional data broadcasting, since one data stream contains only one program, it is sufficient to give one predetermined value for each ES. However, in this embodiment, a data steam flowing in the data steam communication lines 308 contains a plurality of programs, it is impossible to determine from the one predetermined value for each ES which program a data is associated with.

To cope with this, the transference PID 802 given to the data stream flowing in the data stream communication lines 308 is introduced for each combination of “program” and “ES”. Thus, unlike in the case of the conventional data broadcasting in which the PID is “0x270” for both of “Video” of “program A” and “Video” of “program B”, in this embodiment, transference PID 802 for “Video” of “program A” is “0x1270” and that for “Video” of “program B” is “0x1a70”.

The program PID 803 is identical with the conventional one. This is because the data stream to be transmitted from each of the TS routers 304 to its associated broadcasting unit 305 for a local area only contains one program. For example, for both of “Video” of “program A” and “Video” of “program B”, the program PID is “0x270”. Such use of the conventional PID makes it possible to utilize the existing equipments for the broadcasting unit 305 and the recording/editing unit 306 for a local area as they are.

By this, the TS router 304, even when a received data stream contains plural program, is capable of identifying data for each combination of “program” and “ES” by referring to the transference PID 802.

FIG. 9 shows an example of a TS router control profile 408 provided in the program center server 301 in one embodiment of the present invention. The TS router control profile 408 is a table prepared to define functional operations for each of the TS routers 304.

The TS router control profile 408 may consist of a base No. 901, an IP address 902, a broadcasting program 903, a transference program 904 and a recording/edition program 905. The base No. 901 is an identifier for identifying a broadcasting base (a TS router 304). The IP address represents a destination of transmission of a program table 402 and a TS router control profile 408 to a broadcasting base. The broadcasting program 903 represents a program or programs to be broadcast, when a TS router 304 receives a data stream, in the area for which the TS router is responsible. The transference program 904 represents a program or programs to be re-demultiplexed for transference from one TS router 304 to the next TS router 304. The recording/edition program 905 represents a program or programs to be recorded/edited by the recording/editing unit 306 associated with a TS router 304 in the area for which the TS router is responsible.

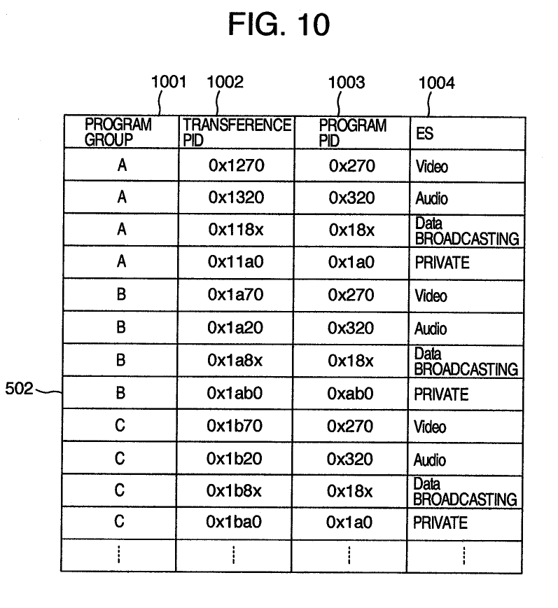

FIG. 10 shows an example of a program table 502 provided in a re-multiplexing unit for transference (TS router) 304 in one embodiment of the present invention. This program table 502 is identical with the program table 402 provided in the program center server 301. Each time the program table 402 in the program center server 301 is updated, the program table 402 so updated or incremental update information is sent to the TS router 304.

The program table 502 may consist of a program group 1001, a transference PID 1002, a program PID 1003 and an ES 1004.

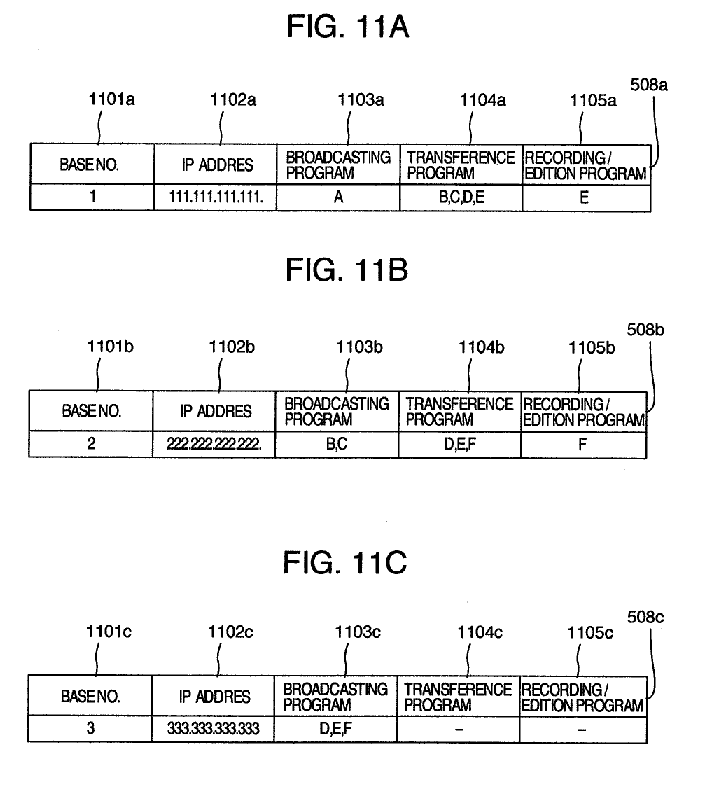

FIGS. 11A to 11C show examples of TS router control profiles 508a, 508b and 508c in respective TS routers 304 in one embodiment of the present invention. These TS router control profiles represent those rows in the TS router control profile 408 in the program center server 301 which are to be distributed from the program center server 301 to the corresponding broadcasting bases. For example, the TS router control profile 508a for the TS router 304 having a base No. “1” is such as shown in FIG. 11A.

The TS router control profile 508a may consist of a base No. 1101a, an IP address 1102a, a broadcasting program 1103a, a transference program 1104a and a recording/edition program 1105a. The TS router control profiles 508b and 508c shown in FIGS. 11B and 11C are similar to the TS router control profile 508a.

An internal operation of the first TS router 304 (router 1) shown in FIG. 7 will be described with reference to FIGS. 5, 8 to 10 and 11A to 11C. In FIG. 9, the first row of the TS router control profile 408 has “1” for the base No. 901, which indicates the first TS router 304 (TS router 1) shown in FIG. 7. Since the first TS router 304 has for its IP address 902 “111.111.111.111”, the program center server 301 transmits the program table 402 (FIG. 8) and a row having for its base No. “1” in the TS router control profile 408 (FIG. 9) to the destination represented by the above IP address, i.e., to the first TS router 304.

The first TS router 304, upon receipt of the program table 402 and the TS router control profile 408, overwrites therewith the program table 502 and the TS router control profile 508 in the first TS router 304 to thereby update its program table 502 and its TS router control profile 508. By this process, the first TS router 304 becomes ready for reception of a data stream.

Next, the first TS router 304 receives from the program center server 301 a data stream containing programs A, B, C and D. The first TS router 304 has its program MPEG-2 TS remote controller client 501 refer to the program table 502 (FIG. 10) and the TS router control profile 508a (FIG. 11a) received. It can be understood that “program A” is broadcast in the area for which the TS router is responsible in accordance with the broadcasting program 1103a, and that “program B”, “program C”, “program D” and “program E” are transferred to the second TS router 304 (router 2) in accordance with the transference program 1104a, the “program E” being recorded/edited in the area for which the TS router is responsible in accordance with the recording/edition program 1105a

As described above, the first TS router 304 refers to the program table 502 and the TS router control profile 508a distributed thereto to split the received data stream into “program A”, “program B”, “program C” and “program D” at its MPEG-2 TS demultiplexing section 505. The “program A” to be broadcast to the area for which the TS router is responsible is transmitted from the MPEG-2 TS multiplexing section 507 to the broadcasting unit 305 in the form of a data stream.

Further, the “program E” recorded/edited by the recording/editing unit 306 in the area for which the first TS router 304 is responsible is combined with “program B”, “program C” and “program D” at the MPEG-2 TS re-muliplexing section 506 for transference to the second TS router 304 (TS router 2) in the form of a data stream.

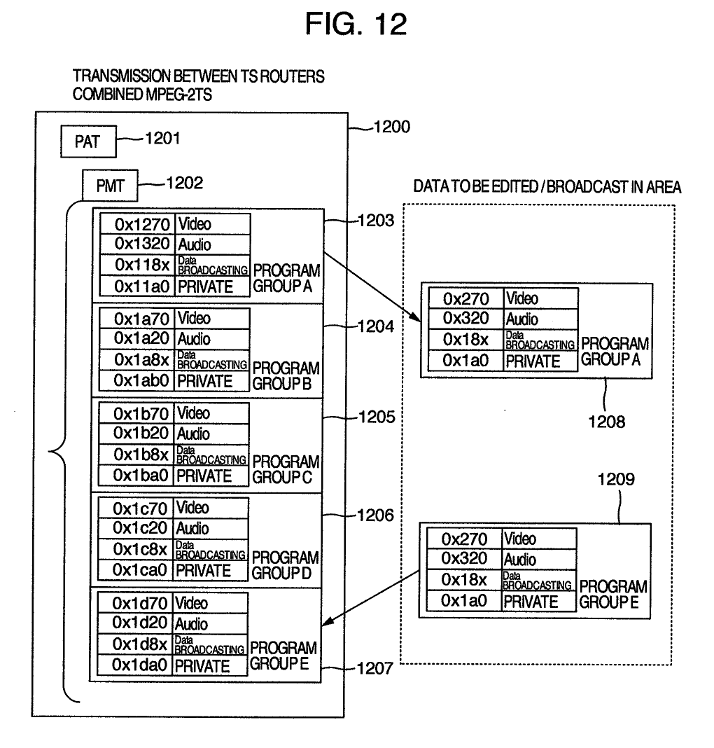

FIG. 12 illustrates an example of a structure of, a manner of demultiplexing from and a manner of insertion into a data stream 1200 which may be received by the first TS router 304 in one embodiment of the present invention. The data stream 1200, when received by the first TS router 304, is in the form of an MPEG-2 TS including a PAT (Program Association Table) 1201, a PMT 1202, a program group A 1203 which is data of “program A”, a program group B 1204 which is data of “program B”, a program group C 1205 which is data of “program C” and a program group D 1206 which is data of “program D”.

The PAT 1201 stores therein, in the form of a PID list of a PMT (Program Map Table), a list of “programs” contained in the transport stream, and the PMT 1202 stores therein PIDs of “digital video”, “digital audio”, etc. The program group A 1203, the program group B 1204, the program group C 1205 and the program group D 1206 are data constituting the respective programs.

The first TS router 304, based on the TS router control profile 508a, refers to the PAT 1201 and PMT 1202 in the data stream 1200 to thereby extract or acquire the program group A 1203. Thereafter, the first TS router 304 refers to the program table 502 to thereby convert the transference PID of the program group A 1203 to the corresponding program PID so that the extracted program group 1203 A is made to be a program group A 1208 to be broadcast. The first TS router 304 transmits the program group A 1208 to the broadcasting unit 305 associated therewith to broadcast the “program A” in the area for which the first TS router 304 is responsible.

Here, the reason why the transference PID is converted to the program PID is that the broadcasting unit 305 is implemented with the conventional structure in this embodiment which is not capable of operating with the transference PID. Consequently, a program PID which is the conventional PID is newly given to each of the constituent elements of the program group A 1208, so that the broadcasting unit 305 is allowed to broadcast the program by referring to the program PID.

Further, the first TS router 304, based on the TS router control profile 508a, converts the program PID of the program group E 1209 recorded/edited by the recording/editing unit 306 to the corresponding transference PID by referring to the program table 502 so that the recorded/edited program group E 1209 is made to be a program group E 1207.

As has been described above, a plurality of programs are transferred successively or in a “relay race” fashion to TS routers (re-multiplexing unit for transference) 304 installed in the respective broadcasting bases, thereby suppressing use of broadcasting center resources (resources for the program center server 301, in the above embodiments) and the communication traffic.

Although, in the above-described embodiments, the data stream is transferred successively or in a “relay race” fashion in one direction, the data transference may be performed in a bidirectional mode by adding a transference direction attribute to the TS router control profiles 408 and 508 or by any other means.

The various members in the above embodiments may be implemented with similar ones having different structures: the program center server may be a center server, a distributing server or a server; the TS router (re-multiplexing unit for transference) may be a relay, a relaying unit or apparatus, a relaying/distributing unit or relaying server; the TS router and the broadcasting unit may be implemented with a combined relaying and broadcasting unit; the TS router and the recording/editing unit may be implemented with a combined relaying and recording/editing unit; and the TS router, the broadcasting unit and the recording/editing unit may be a relay, or a combined relaying, broadcasting and recording/editing unit, or a combined relaying and broadcasting unit.

Further, the broadcasting PID may be a broadcasting ID, the transference PID may be a transference ID, the program may be contents or a contents item, and the “digital video” or “digital audio”, etc constituting a program may be a contents element.

The TS router control profile may be a profile or control information, the program table may be a table defining a relation between the transference ID and the broadcasting ID, the MPEG-2 TS routing controller client may be a controller, the MPEG-2 TS demultiplexing section may be a demultiplexer, and the MPEG-2 TS re-multiplexing section may be a re-multiplexer.

It should be further understood by those skilled in the art that although the foregoing description has been made on embodiments of the invention, the invention is not limited thereto and various changes and modifications may be made without departing from the spirit of the invention and the scope of the appended claims.

1. A contents distributing system in a broadcasting system in which an ID is given to each of a plurality of contents elements constituting one contents item, said ID being capable of uniquely identifying each of said contents elements, and said contents elements are multiplexed to a data stream for transmission and reception, the contents distributing system having a distributing server for distributing contents items and a plurality of relaying units for relaying and broadcasting the distributed contents items, wherein:
said distributing server and said plurality of relaying units are connected in tandem one to another through contents distributing communication lines;
said distributing server assigns a transference ID to each of said contents elements, said contents ID being capable of uniquely identifying a contents item and a kind of the contents element, and transmits a data stream to said relaying units connected in tandem, said data stream containing multiplexed contents elements of said plurality of said contents items; and
said plurality of relaying units receives said data stream from said distributing server sequentially in an order of connection in tandem one from another, in which each of said plurality of relaying units identifies said multiplexed contents elements in said data stream by means of the transference IDs, extracts a contents item to be broadcast in the relaying unit and transfers said data stream to a next one of said relaying units.

2. A contents distributing system according to claim 1, wherein:
said distributing server is connected with each of said plurality of relaying units through a control information communication line and transmits control information to each of said relaying units through said control information communication line, said control information being for controlling operations of said relaying units; and
each of said plurality of relaying units acquires from said data stream a contents item to be broadcast in accordance with said control information received, and determines a contents item to be transferred to a next one of said relaying units in accordance with said received control information.

3. A contents distributing system according to claim 2, wherein each of said relaying units is connected with a broadcasting unit for broadcasting a contents item, and converts a transference ID of a contents element of said contents item acquired from said data stream to a broadcasting ID which is necessary for said broadcasting unit to identify said contents element and transmits said contents item to said broadcasting unit.

4. A contents distributing system according to claim 3, wherein each of said relaying units has a table defining a correspondence between the transference ID and the broadcasting ID for each of said contents elements, and converts, based on said table, said transference ID of the contents element to a corresponding broadcasting ID.

5. A contents distributing system according to claim 4, wherein said broadcasting units serves to digital-broadcast said contents items.

6. A contents distributing system according to claim 1, wherein said data stream is an MPEG-2 TS.

7. A relaying apparatus installed in each of bases for broadcasting a contents item in a digital broadcasting system, comprising:
a demultiplexing section for demultiplexing contents items from a data stream received from a first another one of the relaying apparatuses;
a multiplexing section for a broadcasting unit, said multiplexing section serving to transmit at least a part of the demultiplexed contents items to said broadcasting unit;
a re-multiplexing section for re-multiplexing said demultiplexed contents items for transmission to a second another one of the relaying apparatuses; and
a controller for controlling said multiplexing section and said re-multiplexing section.

8. A relaying apparatus according to claim 7, wherein said controller has a profile for determining whether said demultiplexed contents items be reproduced and whether said demultiplexed contents items be transferred so that said demultiplexing section and said re-multiplexing section are controlled in accordance with said profile.

9. A relaying apparatus according to claim 8, wherein each of said contents items includes a plurality of contents elements, said demultiplexing section serving to split said data stream into contents elements and said re-multiplexing section serving to re-mutiplex said split contents elements.

10. A relaying apparatus according to claim 9, wherein:
a transference ID is given to each of said contents elements, said transference ID being capable of uniquely identifying a contents element and a kind of the contents element; and
said controller serves to determine, based on said transference ID, whether said program elements be broadcast and whether said program elements be transferred.

11. A relaying apparatus according to claim 10, wherein said demultiplexing section serves to convert the transference ID of a contents element, which constitutes a contents item acquired from said data stream, to a broadcasting ID which is necessary for a broadcasting unit to identify said contents element.

12. A relaying apparatus according to claim 11, wherein said controller has a table defining a correspondence between a transference ID and a broadcasting ID for each of said contents elements and serves to convert, based on said table, said transference ID of the contents element to a corresponding broadcasting ID.

13. A relaying apparatus according to claim 12, wherein said broadcasting unit serves to digital-broadcast said contents items.

14. A relaying apparatus according to claim 10, wherein said data stream is an MPEG-2 TS.
